(19) United States
(12) Patent Application Publication
(10) Pub. No.: US 2012/0138046 A1
(43) Pub. Date: Jun. 7, 2012

(54) MOUNTING BRACKET

(75) Inventor: Christopher Carroll KYTE, Jonesborough, TN (US)

(73) Assignee: Meco Corporation, Greeneville, TN (US)

(21) Appl. No.: 13/293,623

(22) Filed: Nov. 10, 2011

Related U.S. Application Data
(60) Provisional application No. 61/419,636, filed on Dec. 3, 2010.

(51) Int. Cl. A47J 37/07; F16M 13/02; B23P 11/00

(52) U.S. Cl. 126/39 B; 29/428; 248/220.21; 248/224.8

(57) ABSTRACT

A mounting bracket for connecting a baffle to a cooking grill includes a curved tab and a straight tab. The curved tab may be curved between about 120° and about 180° from a vertical orientation. The grill may also include a front bracket with a right-angle tab.

### CROSS-REFERENCE TO RELATED APPLICATIONS

This application claims priority under 35 U.S.C. §119(e) to provisional U.S. Patent Application No. 61/419,636, filed Dec. 3, 2010, the disclosure of which is expressly incorporated by reference herein in its entirety.

### BACKGROUND OF THE PRESENT DISCLOSURE

1. Field of the Present Disclosure

The present disclosure is directed to a device for mounting components of a cooking grill, including a grilling surface or cooking grid and a baffle. The present disclosure also includes a method for mounting a baffle on a bracket.

2. Related Art

Cooking grills, including, e.g., barbecue grills, gas grills, and the like, with baffles are known in the art. For example, co-pending U.S. patent application Ser. No. 12/534,992 discloses a grill that may use baffles of different sizes or configurations. In general, baffles may be used to improve the heat distribution in a grill to create a more uniform temperature at the grilling surface or cooking grid. In this regard, baffles may also be known by various alternate names, such as, e.g., heat tents, flavor activators, and the like. Regardless of the nomenclature, their function remains the same.

For example, it is often the case that a barbecue grill has a range of temperatures across its grilling surface. This may be particularly true for gas grills, which employ burners. Circular burners provide optimum heat directly above the burner, with the temperature decreasing radially from the burner. When a piece of food is placed off-center relative to the burner, the part of the food closest to the burner may cook faster than parts that are farther away. In extreme cases, the part closest to the burner may be overcooked or burned white the more distant portions may be dangerously undercooked, i.e. not heated to a temperature sufficient to kill any contaminating microorganisms that may be present. Tube burners may provide a uniform cooking temperature along their length, but the temperature may still decrease in a lateral direction from the burner.

Some grills position a baffle above each burner to provide a more uniform cooking temperature. The baffle disrupts the flow of heated air from the burner to the cooking surface. Instead of traveling directly from the burner to the cooking grid (and food), the air is redirected by the baffle, producing eddy currents and various patterns of air flow. The end result is that the cooking temperature at the grill surface is more uniform. It is easier to consistently and thoroughly cook an item of food, regardless of where it is placed relative to the burner.

Charcoal grills may have a more uniform cooking temperature as the briquettes are spread out inside the grill, but they may nonetheless suffer from hot spots and cold spots. In addition, the location of these variations may not be predictable as they are with gas grills. Wood-fired stoves may also suffer from these problems. Thus, the present disclosure may be suited for use with any grill or cooking apparatus, regardless of its fuel source.

Regardless of the grill type, baffles are support in the grill by mounting brackets. Typically, there are two brackets for each baffle, although alternate arrangements are possible. A bracket may have one or two tabs for retaining the baffle, and one of the tabs may incorporate a right-angle bend. The bent tab is intended to retain the baffle on the bracket, but it is often ineffective at doing so.

A baffle may become dismounted or unattached to its bracket during shipping, transportation, or storage of the grill. For example, a grill may be placed in a vertical orientation, rather than its usual horizontal orientation, e.g., when it is being placed in a vehicle for transportation between home and a grilling location, such as, e.g., a campground. A portable grill may also be stored vertically for many weeks or months between uses. Even larger grills, which might normally reside, e.g., on a user's deck or patio, may be stored horizontally during shipping from the manufacturer to a retail location. In addition, a grill may be subjected to unusual forces during shipping or transportation. In any or all of these situations, a baffle may become disconnected from its mounting bracket, even though the bracket may incorporate a bent or right-angle tab intended to retain the baffle.

Baffles that do not stay in position may be frustrating for end users. The need to manually reseat each baffle prior to each use of the grill may be burdensome to some users and may create a negative image or impression of a particular brand in the mind of the user.

Furthermore, baffles that come free of their mountings may be damaged or may damage other components of the grill. If this damage occurs while the grill is being transported by an end user, it may impose unwanted and unexpected financial loss to the user. If the damage happens while the grill is being shipped to a retailer, the manufacturer or retailer may have to bear the cost of replacing the damaged parts.

Accordingly, there is a need for a mounting bracket that reliably holds, retains, and secures baffles during shipping, transportation, and/or storage.

### SUMMARY OF THE PRESENT DISCLOSURE

The present disclosure meets the foregoing need and allows baffles to be securely mounted without coming loose using curved tabs on the mounting bracket, which results in a significant increase in retention of the baffles and other advantages apparent from the discussion herein.

Accordingly, one aspect of the present disclosure describes a mounting bracket that includes a body, a first side connected to the body, a first grill cutout located on the first side, a first arm connected to the first side, a curved tab connected to the first arm, a second side connected to the body, a second grill cutout located on the second side, a second arm connected to the second side, and a straight tab connected to the second arm. The mounting bracket may also include a first baffle cutout defined by the curved tab, the first arm, and the first side, as well as a second baffle cutout defined by the straight tab, the second arm, and the second side. The mounting bracket may have a hold in the body for receiving a fastener. The mounting bracket may additionally include a first grill tab located adjacent to the first grill cutout and a second grill tab located adjacent to the second grill cutout. The first grill tab may be configured to substantially retain a cooking grid in the first grill cutout, and the second grill tab may be configured to substantially retain a cooking grid in the second grill cutout. The curved tab may be curved away from the second side, and it may be curved about a horizontal axis. The curved tab may be curved between about 120° and about 180° from a vertical orientation. The curved tab may be curved between about 160° and about 170° from a vertical orientation or about 165° from a vertical orientation.

According to another aspect of the present disclosure, a method may be used to install a baffle in a cooking grill. The baffle includes a first side with a first hole, a center with a center hole, and a second side with a second hole. The cooking grill includes a first bracket and a second bracket. The method includes orienting the baffle so that the center of the baffle is parallel to a line between the first bracket and the second bracket, sliding the first hole over a curved tab on the first bracket, rotating the baffle, fitting the second hole over a straight tab on the first bracket, twisting the baffle, and fitting the center hole over a right-angle tab on the second bracket.

The method may also include orienting the baffle so that the first side is below the second side. In addition, the curved tab on the first bracket may be curved about a horizontal axis. The curved tab on the first bracket may be curved between about 120° and about 180° from a vertical orientation. The curved may be curved between about 160° and about 170° from a vertical orientation or about 165° from a vertical orientation.

Additional features, advantages, and aspects of the present disclosure may be set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

### BRIEF DESCRIPTION OF THE DRAWINGS

The accompanying drawings, which are included to provide a further understanding of the present disclosure, are incorporated in and constitute a part of this specification, illustrate aspects of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1A shows a top view of a bracket according to an aspect of the present disclosure;

FIG. 1B shows a front view of the bracket;

FIG. 1C shows a left side view of the bracket;

FIG. 1D shows a right side view of the bracket;

FIGS. 2A and 2B show a left isometric and a right isometric view, respectively, of the bracket;

FIG. 3 shows a front view of the bracket with a baffle in place;

FIG. 4 shows an example of grill that may be fitted with one or more mounting brackets;

FIG. 5 shows a front bracket according to an aspect of the grill;

FIG. 6 shows the grill of FIG. 4 with two baffles installed;

FIGS. 7A and 7B show the mating of the baffle to the mounting bracket and the front bracket, respectively; and

FIG. 8 shows a cutaway side view of the grill with a baffle and a cooking grid installed.

### DETAILED DESCRIPTION OF THE PRESENT DISCLOSURE

The aspects of the present disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the present disclosure. The examples used herein are intended merely to facilitate an understanding of ways in which the present disclosure may be practiced and to further enable those of skill in the art to practice the aspects of the present disclosure. Accordingly, the examples and aspects herein should not be construed as limiting the scope of the present disclosure, which is defined solely by the appended claims and applicable law. Moreover, it is noted that like reference numerals represent similar parts throughout the several views of the drawings.

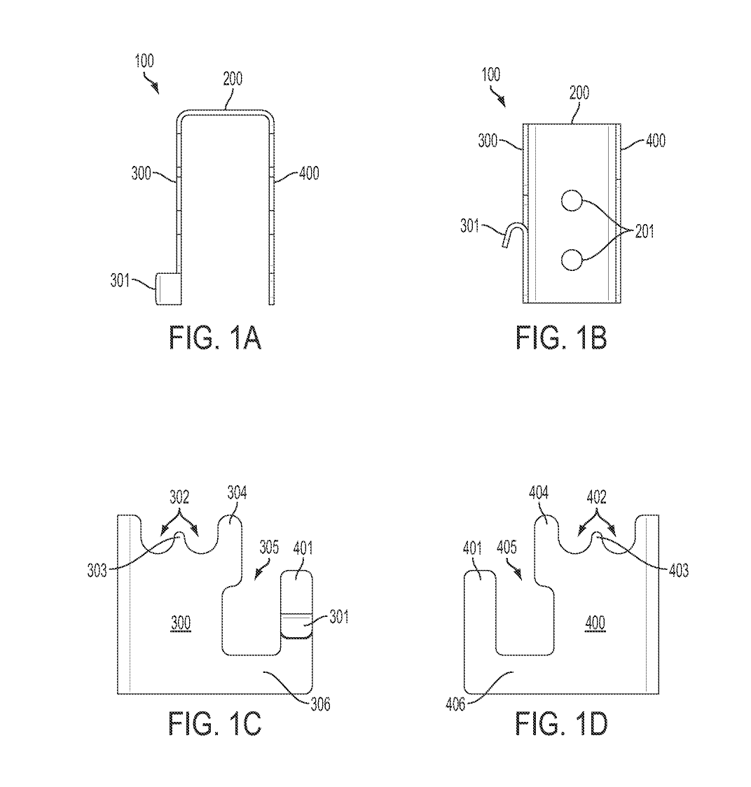

FIG. 1A shows a top view of a bracket 100 according to an aspect of the present disclosure. The bracket 100 may be made from cold rolled steel, galvanized steel, aluminum, heavy gauge aluminum, or the like. For example, the bracket 100 may be made from cold rolled steel with a thickness of about 1.2 mm. The bracket 100 may be electroplated with a black finish. The bracket 100 may include a body 200, a first side 300, and a second side 400. The sides 300, 400 may be arranged at an angle of about 90°, i.e. substantially perpendicular, to the body 200.

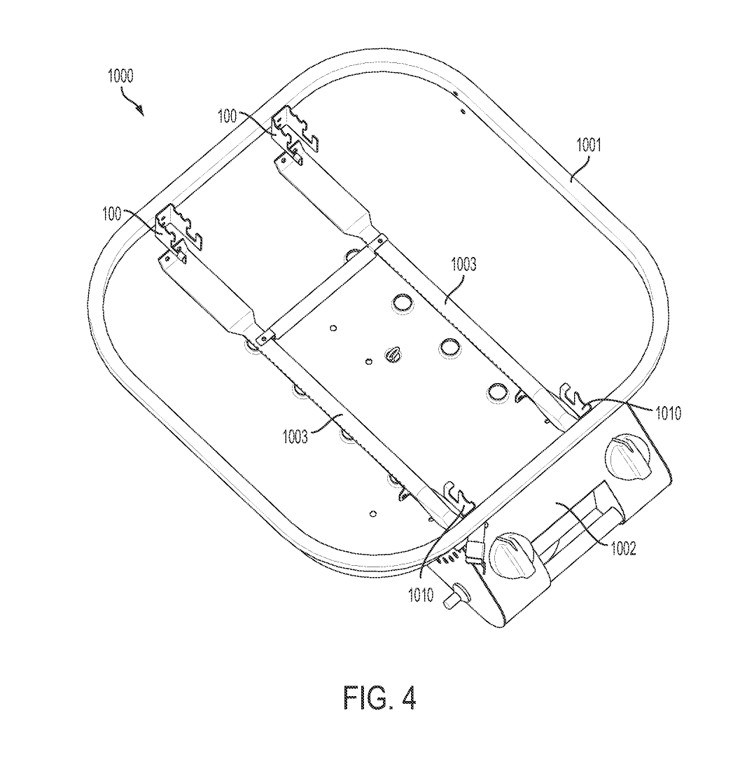

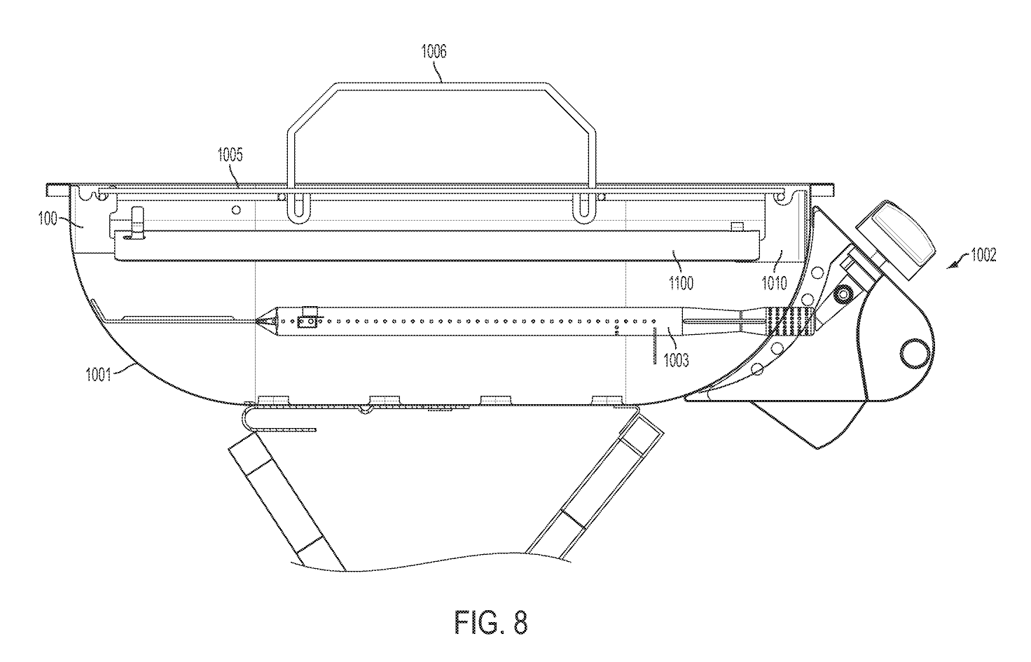

FIG. 1B shows a front view of the bracket 100. The body 200 may include one or more holes 201 for receiving a fastener such as a screw, bolt, rivet, pin, or the like. The fasteners may be used to attach the bracket 100 to a grill 1000 (shown in FIG. 4). Alternatively, the bracket 100 may be attached to the grill by welding, an adhesive, or similar technique. The bracket 100 may be located inside the grill 1000 and may be positioned, for example, to support a grill surface or cooking grid 1005 (shown in FIG. 8), as well as provide additional functions as discussed below. The bracket 100 may be located on the inside of the rear wall of the firebox 1001, such that a user standing at the controls 1002 of the grill 1000 may view the bracket 100 from the front as shown in FIG. 1C. Accordingly, body 200 may also be known as the rear 200 of the bracket 100, the first side 300 as the left side 300, and the second side 400 as the right side 400.

FIG. 1C shows a left side view of the bracket 100. The left side 300 of the bracket 100 may include a curved tab 301 for locking or retaining a baffle 1100 or other structure on the bracket 100, as discussed below. The tab 301 may be connected to the side 300 by an arm 306, which may also serve to support a baffle 1100 or other structure. The tab 301, the arm 306, and the side 300 may define a baffle cutout 305 for assisting in accepting and retaining one or more baffles 1100. In addition to retaining a baffle 1100, the left side 300 of the bracket 100 may also be adapted to support a grill surface or cooking grid 1005. For example, the left side 300 may include one or more grill cutouts 302. The grill cutouts 302 may be sized, positioned, or otherwise oriented to receive a bar of the grill surface or cooking grid 1005. For example, two cutouts 302 may be separated by a cutout separator 303. In addition, a grill tab 304 may be located adjacent to one of the cutouts 302. The tab 304 may be sized and positioned to tit in between, e.g., bars of a grilling grid 1005. The tab 304 may be wide enough to contact two bars simultaneously, thereby preventing the grid 1005 from sliding back and forth in the cutouts 302. The tab 304 may also frictionally hold the grill or grid 1005 in place in case of sudden jolts to the grill 1000, rocking of the grill 1000, or other instability.

FIG. 1D shows a right side view of the bracket 1000. The right side 400 of the bracket 100 may include a straight tab 401, which may help the curved tab 301 to retain a baffle 1100 on the mounting bracket. The tab 401 may be connected to the side 400 by an arm 406. The tab 401, the arm 406, and the side 400 may define a baffle cutout 405. The right side may also include one or more grill cutouts 402, a cutout separator 403, and a grill tab 404. Each of the components of the right side 400 may function similarly or identically to its corresponding component from the left side 300.

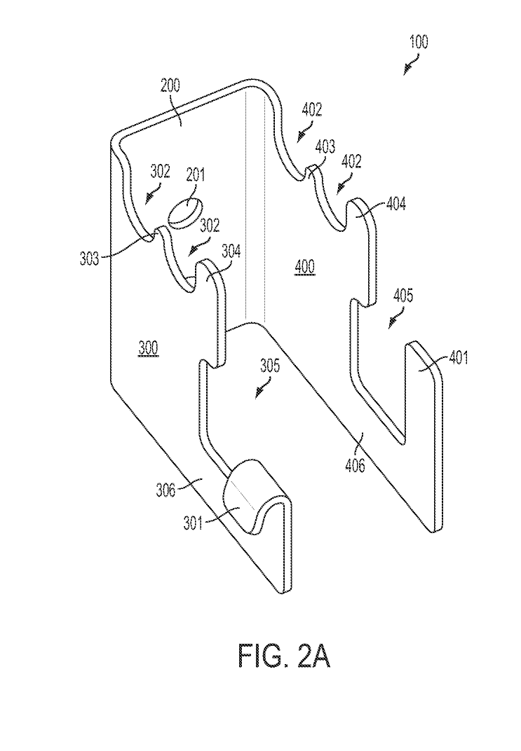

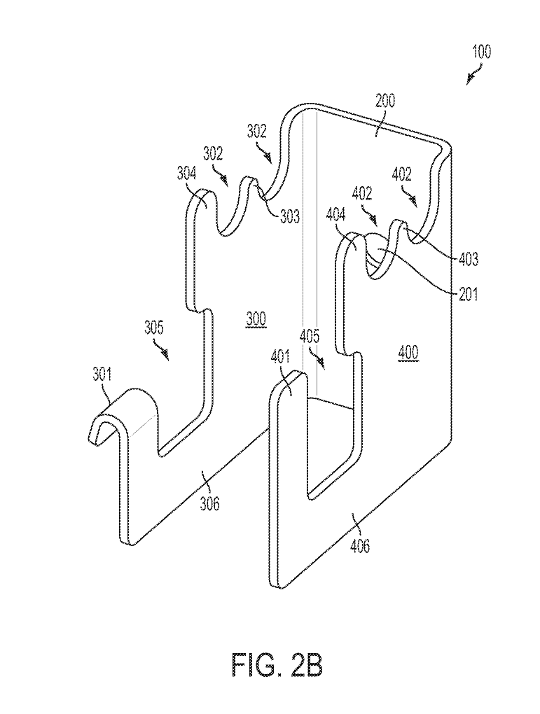

FIGS. 2A and 2B show a left isometric and a right isometric view, respectively, of the bracket 100. These views illustrate that the left side 300 and the right side 400 may be connected to body 200 at right angles. Furthermore, the left side 300 may be very similar structurally to the right side 400. For example, both sides 300, 400 may have one or more cutouts 302, 402; cutout separators 303, 403; grill tabs 304, 404; baffle cutouts 305, 405; and arms 306, 406. A difference between the sides 300, 400 may be the curved tab 301 in place of the straight tab 401, FIGS. 2A and 2B also show the position of the hole 201 relative to the sides 300, 400.

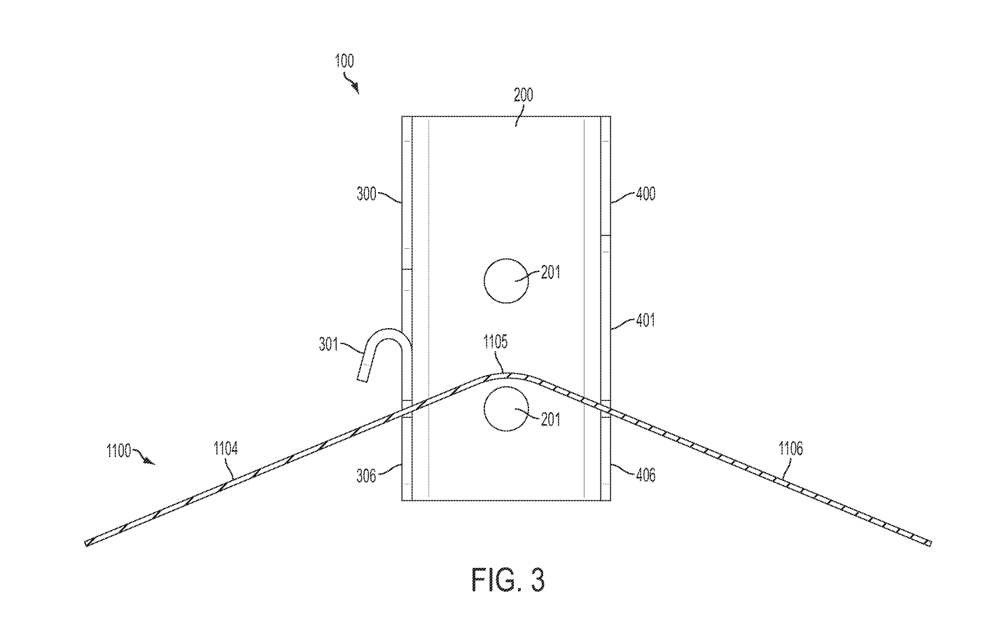

FIG. 3 shows a front view of the bracket 100 with a baffle 1100 in place. Curved tab 301 may pass through a hole 1101 in the baffle 1100, and straight tab 401 may pass through a corresponding hole 1102 in the baffle. The curved tab 301 may be curved about a horizontal axis that is substantially perpendicular to the body 200 and substantially parallel to the left side 300. The angle of the curved tab 301 may be measured relative to the shape the tab 301 would have if it were identical to the straight tab 401. Based on this measure, the curved tab 301 may be curved between about 120° and about 180° from the vertical, the orientation it would have had if it were not curved. A tab 301 that is curved about 180° may be pointed down toward the base of the bracket 200 and substantially parallel to its own base, where the tab 301 connects to the arm 306. According to an additional aspect of the present disclosure, the curved tab 301 may be curved between about 160° and about 170°. According to a further aspect of the disclosure, the curved tab 301 may be curved about 165°.

The baffle 1100 itself may rest on the left arm 306 and the right arm 406. The baffle 1100 may include two angled portions: a left side 1104 that may rest on the left side 300 of the bracket 100 and a right side 1106 that may rest on the right side 400 of the bracket. The left side 1104 and the right side 1106 of the baffle 1100 may be joined by a center portion 1105. The center portion 105 may, for example, include a curved region that joins the left side 1104 to the right side 1106, or the center portion 1105 may include a flat region that is joined to the left side 1104 by a curved region and to the right side 1106 by a second curved region. The center portion 1105 may define a long or longitudinal a of the baffle 1100. The angle between the left side 1104 and the right side 1106 may be, e.g., about 90°, about 120°, or any other appropriate angle, depending on the particular properties of the grill 1000. Such properties may include, e.g., the number and type of burners in the grill, the fuel used by the grill, the number of baffles per burner, and the spacing between the baffles.

FIG. 4 shows an example of grill 1000 that may be fitted with one or more mounting brackets 100. The grill may, for example, include a firebox 1001 and a set of controls 1002 for operating the grill. Inside the firebox 1001, there may be one or more burners 1003. While FIG. 4 shows a grill 1000 with two tube burners 1003, one having ordinary skill in the art will appreciate that a mounting bracket according to the present disclosure may be used with a grill have any number or type of burners, including, for example, tube burners, round burners, square burners, and the like. Any type of grill may be amenable to the use of baffles and thus include or benefit from a mount bracket 100. For example, gas grills, charcoal grills, wood-burning grills, and the like may all benefit from more even heat distribution through the use of baffles, and the mounting bracket 100 of the present disclosure may be used with all types of grills.

As shown in FIG. 4, a bracket 100 may be mounted on the interior of the rear of the firebox 1001. The bracket 100 may be attached to the firebox 1001 with one or more fasteners, such as, e.g., a screw, a bolt, a rivet, a pin, or the like. Alternatively or additionally, the bracket 100 may be attached to the firebox 1001 by welding, adhesives, or the like. As will be understood by one skilled in the art, any attachment method may be used, so long as it will remain stable at the high temperatures found in the firebox 1001 while the grill 1000 is in use.

For each baffle in the grill, there may be one bracket 100, and each bracket 100 may be paired with a front bracket 1010. For grills that use one baffle 1100 for each burner 1003, there may be a mounting bracket 100 and a front bracket 1010 pair for each burner. For example, FIG. 4 shows a grill 1000 with two burners 1003, two mounting brackets 100, and two front brackets 1010. Some grills, however, may use more than one baffle 1100 per burner 1003. Such grills may use more than one mounting bracket 100 and more than one front bracket 1010 for each burner. For example, a grill with more than one baffle 1100 per burner 1003 may use one mounting bracket 100 and one front bracket 1010 for each baffle 1100. Similarly, a grill that uses fewer than one baffle per burner may also use one mounting bracket 100 and one front bracket 1010 for each baffle 1100.

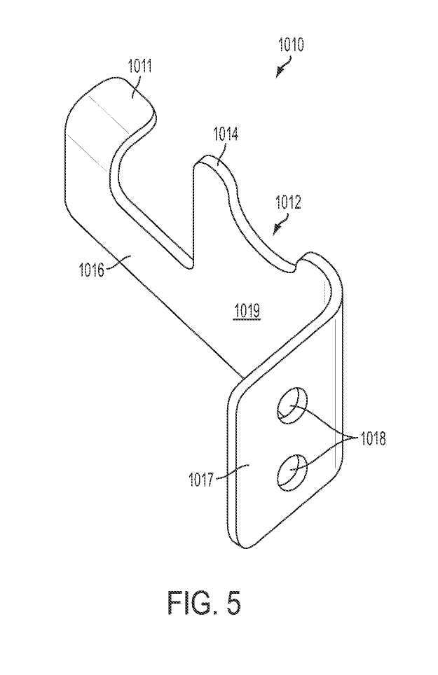

FIG. 5 shows a front bracket 1010. The front bracket 1010 may be similar in design to the mounting bracket 100. For example, the front bracket 1010 may include a body 1017 with one or more holes 1018 to receive a fastener for attaching the front bracket 1010 to the firebox 1001. Where the mounting bracket 100 may have two sides 300, 400, the front bracket 1010 may only have one side or projection 1019, which may be set at a right angle to the body 1017 of the front bracket 1010. The projection 1019 may include one or more grill cutouts 1012 for supporting a grill surface or cooking grid 1005, a tab 1014 for retaining a baffle 1100, and an arm 1016 connecting the tab 1011 to the projection. The projection 1019, arm 1016, and tab 1011 may define a baffle cutout 1015, which may receive and/or support the baffle 1100.

The top portion of the tab 1011 of the front bracket 1010 may be bent at a right angle to the rest of the tab 1011. For example, if the front bracket 1010 is mounted in a vertical orientation, the right-angle tab 1011 may be oriented to have a horizontal direction. When viewed from the controls 1002 of the grill 1000, the right-angle tab 1011 of the front bracket may be oriented or pointed in the opposite direction of the curved tab 301. By orienting the curved tab 301 and the right-angle tab 1011 in opposite directions, the mounting bracket 100 and the front bracket 1010 may work together to retain the baffle 1100 on both brackets 100, 1010. For example, each tab 301, 1011 may permit a small amount of movement or rotation in the direction it points. Since the tabs 301, 1011 point in opposite directions, each tab may prevent the baffle 1100 from working itself free of the other tab during shipping, transportation, storage, or the like.

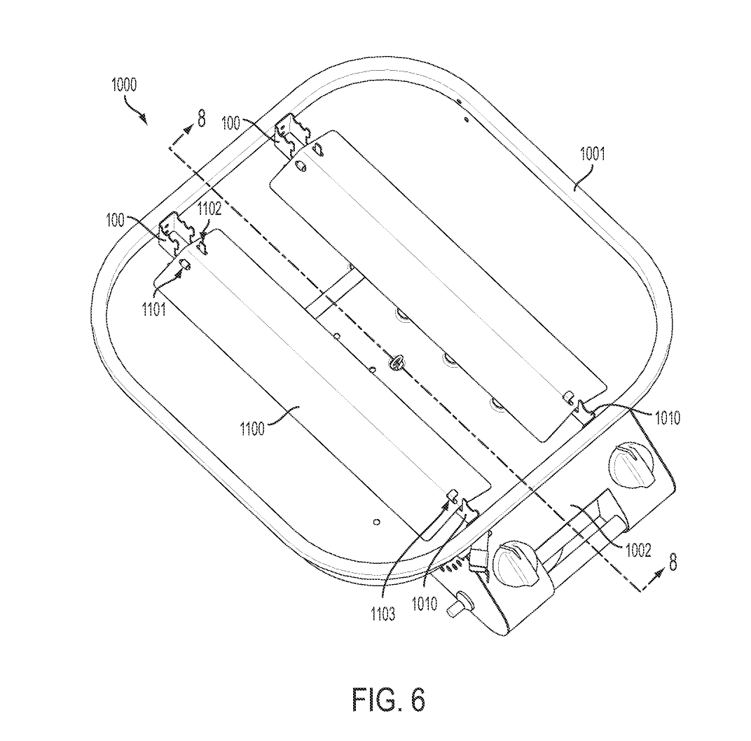

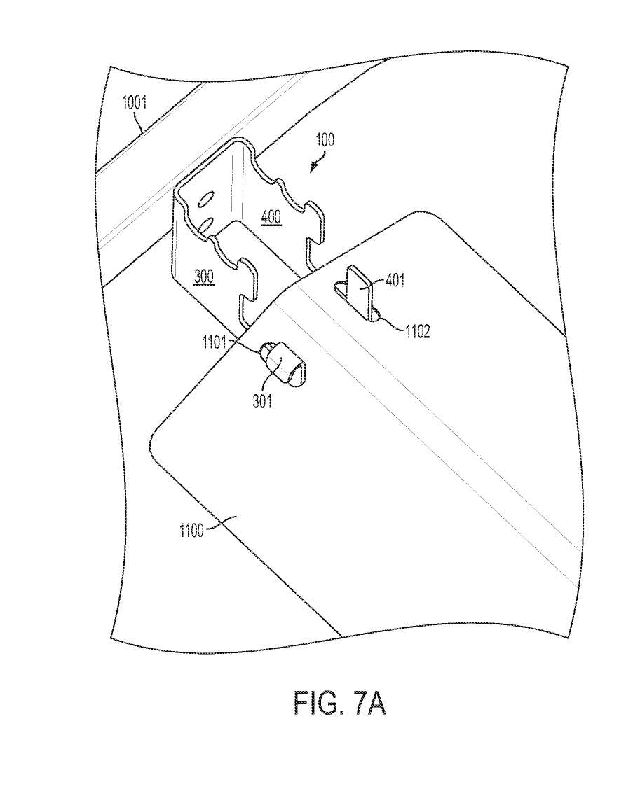

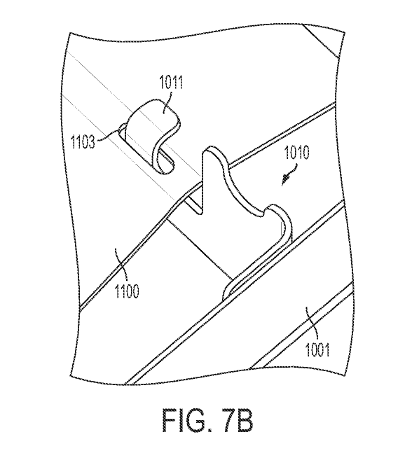

FIG. 6 shows the grill 1000 of FIG. 4 with two baffles 1100 installed. Each baffle 1100 may be fitted with three holes 1101, 1102, 1103 for mating with the brackets 100, 1010. FIGS. 7A and 7B show the mating of the baffle 1100 to the mounting bracket 100 and the front bracket 1010, respectively. As seen in FIG. 7A, for example, the hole 1101 may be positioned on the left side 1104 of the baffle 1100 and may receive the curved tab 301. As a second example, the hole 1102 may be located on the right side 1106 of the baffle 1100 and may receive the straight tab 401. The hole 1103 may, e.g., be located on the center 1105 of the baffle 1100 and may receive the right-angle tab 1011, as seen in FIG. 7B.

A baffle 1100 may be installed onto a mounting bracket 100 and a front bracket 1010 by orienting the baffle 1100 with its long axis, which may be defined by the center 1105, parallel to an axis from the mounting bracket 100 to the front bracket 1010. The baffle 1100 may then be rotated about its long axis into a somewhat vertical direction, with the left side 1104 of the baffle below the right side 1106. The baffle may be moved so that the curved tab 301 slides partially through the hole 1101. The side of the hole 1101 may catch underneath the curved tab 301, e.g., in its hook or elbow. The baffle may then be rotated or rolled onto the right side 400 of the bracket 100 while simultaneously coming to rest on the front bracket 1010. The straight tab 401 may easily pass through the corresponding hole 1102 in the right side 1106 of the baffle 1100, but the right-angle bend in the right-angle tab 1011 may prevent the tab 1011 from easily passing through the corresponding hole 1103 in the center 1105 of the baffle 1100. Installation may continue by applying pressure to the baffle 1100 to slightly twist the baffle enough to slide the hole 1103 onto the right-angle tab 1011. The baffle 1100 may now be installed onto the mounting bracket 100 and the front bracket 1010. In addition, the configuration of the tabs, namely the use of the curved tab 301 and/or the use of the right-angled tab 1011, may lock the baffle 1100 onto the mounting bracket 100 and the front bracket 1010.

FIG. 8 shows a cutaway side view of the grill 1000, taken along line 8-8 in FIG. 6, with a baffle 1100 and a cooking grid 1005 installed. The baffle 1100 may be retained or held in position by one or more of the curved tab 301, the straight tab 401, and the right-angle tab 1011. The grill surface or cooking grid 1005 may include a handle 1006 on one or both sides of the grid. The handle 1006 may make it easier to remove the grid 1005 for purposes of cleaning the grid 1005, the grill 1000, or both. The gill cutouts 302, 402 in the mounting bracket 400 and the grill cutout 1012 in the front bracket 1010 may support the cooking grid 1005.

The baffle 1100 may be spaced closer to or farther from the burner 1003 than is shown in FIG. 8. Similarly, the baffle 1100 may be spaced closer to or father from the cooking grid 1005 than is shown in FIG. 8. Changes in the distance between the baffle 1100 and the burner 1003 may be accomplished by changing the position of the brackets 100, 1010 or by changing the height of the individual brackets, i.e. the distance between the tops of the arms 306, 406, 1016 and the grill cutouts 302, 402, 1012. Changing the distance between the cooking grid 1005 and the baffle 1100 requires changing the height of the individual brackets. While a particular arrangement has been shown in FIG. 8, those skilled in the art will appreciate that the vertical spacing between the burner 1003, the grill 1005, and the baffle 1100 may be altered, as described above, without departing from the spirit and scope of the present disclosure, including the written description and the attached claims.

While the present disclosure has been described in terms of exemplary aspects, those skilled in the art will recognize that the present disclosure can be practiced with modifications in the spirit and scope of the appended claims. These examples given above are merely illustrative and are not meant to be an exhaustive list of all possible designs, aspects, applications or modifications of the present disclosure.

What is claimed is:

1. A mounting bracket comprising:
a body;
a first side connected to the body;
a second side connected to the body;
a first grill cutout located on the first side;
a second grill cutout located on the second side;
a first arm connected to the first side;
a second arm connected to the second side;
a curved tab connected to the first arm; and
a straight tab connected to the second arm.

2. The mounting bracket of claim 1, further comprising:
a first baffle cutout defined by the curved tab, the first arm, and the first side; and
a second baffle cutout defined by the straight tab, the second arm, and the second side.

3. The mounting bracket of claim 1, further comprising a hole in the body configured to receive a fastener.

4. The mounting bracket of claim 1, further comprising:
a first grill tab located adjacent to the first grill cutout, the first grill tab configured to substantially retain a cooking grid in the first grill cutout; and
a second grill tab located adjacent to the second grill cutout, the second grill tab configured to substantially retain a cooking grid in the second grill cutout.

5. The mounting bracket of claim 1, wherein the curved tab is curved away from the second side.

6. The mounting bracket of claim 1, wherein the curved tab is curved about a horizontal axis.

7. The mounting bracket of claim 6, wherein the curved tab is curved between about 120° and about 180° from a vertical orientation.

8. The mounting bracket of claim 7, wherein the curved tab is curved between about 160° and about 170° from a vertical orientation.

9. The mounting bracket of claim 8, wherein the curved tab is curved about 165° from a vertical orientation.

10. A cooking grill comprising:
a mounting bracket configured to support a cooking grid, the first bracket further configured to support a baffle, the mounting bracket comprising a curved tab and a straight tab.

11. The cooking grill of claim 10, wherein the curved tab is curved about a horizontal axis.

12. The cooking grill of claim 11, wherein the curved tab is curved between about 120° and about 180° from a vertical orientation.

13. The cooking grill of claim 12, wherein the curved tab is curved between about 160° and about 170° from a vertical orientation.

14. The cooking grill of claim 13, wherein the curved tab is curved about 165° from a vertical orientation.

15. A method of installing a baffle in a cooking grill, the baffle comprising a first side with a first hole, a center with a center hole, and a second side with a second hole, the cooking grill comprising a first bracket and a second bracket, the method comprising:
orienting the baffle such that the center of the baffle is parallel to a line between the first bracket and the second bracket;
sliding the first hole over a curved tab on the first bracket;
rotating the baffle;
fitting the second hole over a straight tab on the first bracket;
twisting the baffle; and
fitting the center hole over a right-angle tab on the second bracket.

16. The method of claim 15, further comprising orienting the baffle such that the first side is below the second side.

17. The method of claim 15, wherein the curved tab on the first bracket is curved about a horizontal axis.

18. The method of claim 17, wherein the curved tab on the first bracket is curved between about 120° and about 180° from a vertical orientation.

19. The method of claim 18, wherein the curved tab on the first bracket is curved between about 160° and about 170° from a vertical orientation.

20. The method of claim 19, wherein the curved tab on the first bracket is curved about 165° from a vertical orientation.
